(19) United States
(12) Patent Application Publication
(10) Pub. No.: US 2005/0123748 A1
(43) Pub. Date: Jun. 9, 2005

(54) Laminated sheet for supports

(76) Inventor: Dean S. Paris, Takoma Park, MD (US)

Correspondence Address: COOK, ALEX, MCFARRON, MANZO, CUMMINGS & MEHLER LTD, SUITE 2850, 200 WEST ADAMS STREET, CHICAGO, IL, 60606, US

(21) Appl. No.: 10/726,743

(22) Filed: Dec. 3, 2003

(51) Int. Cl. B32B 27/06; B32B 27/32; B32B 27/36

(52) U.S. Cl. 428/337; 428/339; 428/482; 428/483; 428/523; 428/910

(57) ABSTRACT

A laminate for forming structural members and the structural members formed thereby. The laminate has a core with opposite outer surfaces, an outer laminated sheathing attached to each of the opposite outer surfaces of the core. The core has a center film of a biaxially oriented thermoset polyester resin. Each of the outer surfaces of the core is formed of a film of a thermoplastic adhesive resin which fastens to an outer laminated sheathing. Each of the outer sheathings includes an outer film of a biaxially oriented thermoset polyester resin with the outer films of biaxially oriented thermoset resin connected by at least one center film of a thermoplastic adhesive resin. The outer films of biaxially oriented thermoset polyester resin located adjacent the core have a film of thermoplastic adhesive resin facing the outer surfaces of the core. The biaxially oriented thermoset polyester resin is preferably polyethylene terephthalate and the thermoplastic adhesive resin is polyethylene. The structural member is formed from the laminate.

### BACKGROUND OF THE INVENTION

Laminates of oriented polyethylene terephthalate (PET) and polyethylene (PE) have been used extensively in the manufacture of cards and similar items carried by individuals in which a durable, tamper resistant item is required. Because such cards are usually carried by individuals in wallets, purses and similar personal carriers and because many such cards must be inserted into card readers of various types, such cards are relatively small in their linear dimensions and thicknesses and are of standard sizes. While durability, tear resistance and resiliency are important factors in such cards, the resistant to bending in the plane of the card is not an important consideration in the manufacture of such cards.

### SUMMARY OF THE INVENTION

The advantages of a structural member formed from a laminate of this invention such as resistance to bending, lateral flexibility and transparency, are obtained by novel arrangements of component materials that have been known and available for many years for other purposes. Not only are these materials well known, but methods of laminating them have been developed so that they can readily be manufactured into the laminates of this invention using conventional machinery and laminating methods.

The novel arrangements of the laminates of this invention take advantage of the known characteristics and availability of the component materials. The resulting laminates include the provision of a core having a center film of a biaxially oriented thermoset resin adhered to and sandwiched between outer layers, each of which consists of a pair of outer films also of a biaxially oriented thermoset resin held together by two or more films of polyethylene adhesive. The thermoset resin films provide the strength and resistance to bending while the adhesive films maintain the integrity of the strengthening films.

The laminates of this invention may be easily manufactured using commercially available components such as films of biaxially oriented polyethylene terephthalate (PET) having films of polyethylene adhesive (PE) applied to an outer side thereof and films of biaxially oriented polyethylene terephthalate (PET) having films of polyethylene (PE) applied to opposite sides thereof. The PET film with the single layer of polyethylene adhesive (PE) is laminated to a similar film with the polyethylene adhesives in contact with each other forming what is called an outer or sheathing laminate. The outer surface of one of the (PET) films of the sheathing laminate has a film of PE applied thereto. The PET film with adhesives on each side thereof forms a core and is used to connect two sheathing laminates with its PE film adhering to the PE film on the outer surface of the sheathing.

This invention is directed to a laminate of PET and PE which laminate is formed with a sufficiently large bending resistance along the plane of the laminate so that it is capable of being used to form a structural member.

An object of this invention is a PET and PE laminate from which shaped structural elements may be formed.

Another object of this invention is a PET and PE laminate having a core of PET and PE, which core joins together the outer sheathings of PET and PE.

A further object of this invention is a PET and PE laminate useful for forming structural elements having lateral flexibility and resilience in addition to a substantial resistance to bending along the plane of the laminate.

A still further object of this invention is a laminate useful for forming structural members that are transparent.

Other objects of the invention may be found in the following specification, claims and drawings.

### BRIEF DESCRIPTION OF THE DRAWINGS

FIG. 1 is an enlarged cross-sectional view of one embodiment of a laminate of this invention with the thicknesses of the films forming the laminate exaggerated for clarity of illustration;

FIG. 2 is a perspective view of a support element manufactured using the laminate of this invention; and

FIG. 3 is another embodiment of a support element made using the laminate of this invention.

### DESCRIPTION OF THE PREFERRED EMBODIMENTS

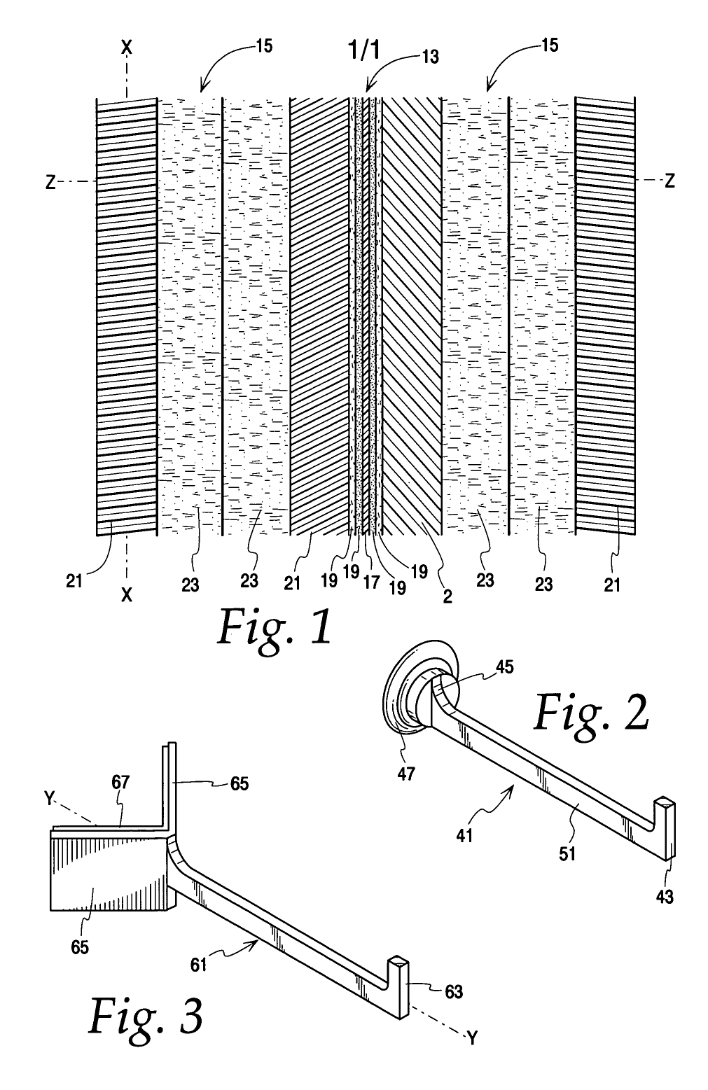

The plastic laminate sheet 11 of the invention, as shown in FIG. 1, includes a relatively thin core 13 and a pair of relatively thick outer strengthening layers 15 laminated to each side of the core 13. The thicknesses of the core and the strengthening layers are not critical but generally the outer strengthening layers are much thicker than the core in this embodiment of the invention.

The core 13 is formed of a center film 17 of a biaxially oriented thermoset polyester resin, preferably polyethylene terephthalate (PET), having a thickness of 0.001 inches (one mil). Films 19, the other elements of the core, are formed of a thermoplastic adhesive resin, e.g., a polyethylene (PE) having a thickness of 0.001 inches (one mil) and these are applied to the outer surfaces of the film 17.

The outer strengthening layers 15 are each five ply, formed of a pair of PET films 21 spaced apart and attached by a pair of PE adhesive films 23. The PET films are each 0.007 inches (seven mils) thick and the PE films are 0.008 inches (eight mils) thick. An additional PE film 19 is applied to the outer surface of the PET film 21 of each strengthening layer 15 which is positioned against the core 13. This additional film of PE provided improved adhesion. When the two outer strengthening layers 15 are assembled on opposite sides of the core 13, the structural laminate sheet 11 has a thickness of approximately 0.065 inches (65 mils). The laminate sheet 11 shown in FIG. 1 becomes the starting material for the structural members or structural supports of the type shown in FIGS. 2 and 3 of the drawings.

The thicknesses of the films 17, 19, 21 and 23 which form the plastic laminate sheet 11 of the preferred embodiment of this invention, both in absolute values and relative to one another, do not constitute the only films that can be used to practice the method of this invention. In the embodiment of FIG. 1, the films of the core 13, PET film 17 and PE adhesive films 19 are each one mil thick and the PET films 21 and PE adhesive films 23 of the outer strengthening layers 15 are seven and eight mils thick, respectively. It is not essential to the practice of the invention that these exact thicknesses and ratios of thicknesses of the films in the outer strengthening members to the thicknesses of the films in the core always be followed. There are advantages in making the core thinner than the outer strengthening members, because the principal purpose of the core is to connect the outer strengthening members while the purpose of the outer strengthening members is to provide resistance to bending. However, there is no reason why all of the films comprising the laminate could not be of the same thickness if films of the thickness selected are commercially available and are compatible with the laminating equipment which is available to the laminator.

In the example shown in FIG. 2, the structural member is an arm 41 shaped from a sheet of laminate 11 with the width of the arm determined by the thickness of the laminate. A hook 43 is integrally formed at one end of the arm 41 and an anchor 45 formed at the opposite end of the arm is attached to a plastic suction cup 47 to enable the hook 41 to be mounted on a wall or other supporting surface. The hook 41 is intended to be attached to a supporting surface so that loading forces will be applied to the upper surface 49 of the hook 41 and, thus, will be acting along the longitudinal or lateral planes of the films 17, 19, 21 and 23 where the resistance of the films to bending is the greatest. Bending forces applied to the side walls 51 of the hook 41 will be resisted by the relatively thick laminate 41 with its multiple layers which will also provide flexibility and resilience.

As shown in FIG. 3 of the drawings, an arm 61 is also formed from a sheet of the plastic laminate 11 with the thickness of the arm determined by the thickness of the laminate. A hook 43 in integrally formed at one end of the arm, and the laminate may be split at the opposite end of the arm to form a pair of mounting plates 63 extending at right angles to each other. A bend piece of double-sided tape 67 is attached to the mounting plate 65 to enable to arm 61 to be attached to a corner of a support.

The arms 41 and 61 as heretofore described are merely illustrative of supports of the type that may be made using the plastic sheet laminate 11 of this invention and it should be understood and appreciated that a multitude of different types, styles and sizes of supports may be made using the laminate 11 of this invention. The structural members or supports thus form using the laminate 11 of this invention are constructed so that bending forces applied to a support structure are applied along an oriented or stretched axis of the films comprising the laminate, especially the films of the outer sheathings 15. Each strip 17 and 21 of biaxially oriented film has a lengthwise of “X” axis, a transverse or “Y” axis and a “Z” axis which is at right angles to both the “X” and “Y” axes with the “Z” axis extending through the thickness of the film. Each biaxially oriented film has its greatest compression strength along its oriented axes, the “X” and “Y” axes and these are the axes which carry the loads in the support structures made from the laminate 11 of this invention. In use, such support structures will also be subjected to lateral forces, e.g., forces that act along the “Z” axis of the films. While a single film of the type used in forming the laminates of sheet 11 will provide little resistance to a bending force along its “Z” axis, the totality of the resistance provided by all the laminated films 17, 19, 21 and 23 will provide a large resistance to bending while also providing resiliency to the support structure to accommodate such lateral forces.

Whereas the laminate of this invention has been shown with a pair of outer sheathings 15 formed with a relatively thin core 13, it should be appreciated that the relative thicknesses of the films of the sheathing and the core can be varied to meet the demands imposed upon such support structures. Also, it should be understood that the thicknesses of the various film may also be varied. Further, while the present laminate consists of 13 separate films of biaxially oriented polyester resin and polyethylene adhesive, that a greater or fewer number of films may be utilized.

1. A laminate for forming structural members including:
a laminated core having a center film of a biaxially oriented thermoset polyester resin having opposite outer surfaces, a film of a thermoplastic adhesive resin attached to each of said outer surfaces of said center film, each of said adhesive resin films having an outer surface, and an outer laminated sheathing attached to each of said outer surfaces of said adhesive resin films of said core,
each of said outer laminated sheathings includes outer films of a biaxially oriented thermoset polyester resin with said outer films of biaxially oriented thermoset polyester resin connected by at least one center film of a thermoplastic adhesive resin.

2. The laminate of claim 1 in which said biaxially oriented thermoset polyester resin is polyethylene terephthalate and said thermoplastic adhesive resin is polyethylene.

3. The laminate of claim 2 in which each of said outer films of said outer laminated sheathings is connected by a pair of center films of polyethylene adhesive.

4. The laminate of claim 1 in which said outer films of each of said sheathings which are positioned adjacent said core include an additional film of thermoplastic adhesive located adjacent said outer surface of each of said adhesive resin films of said core.

5. The laminate of claim 1 in which each of said films of said core are approximately one mil thick.

6. The laminate of claim 1 in which each of said films of said outer sheathing are approximately seven mils thick.

7. A structural member having a pair of load supporting layers each formed by a laminate of multiple adhesive and structural films, with each structural film of said laminate being a biaxially oriented thermoset polyester resin, with each of said load supporting layers positioned to receive a load in a direction of said orientation of said structural films.

8. The structural member of claim 7 in which said biaxially oriented thermoset polyester resin is polyethylene terephthalate and said adhesive film is polyethylene.

9. The structural member of claim 7 in which said laminate of multiple adhesive and structural films includes:
a laminate core having opposite outer surfaces,
a film of thermoplastic adhesive resin attached to each side of said center film, and
an outer laminated sheathing of said structural films attached to each of said opposite outer surfaces of said core.
